(19) United States
(12) Patent Application Publication
(10) Pub. No.: US 2002/0162119 A1
(43) Pub. Date: Oct. 31, 2002

(54) Upstream hi-phy lite system

(76) Inventors: Ariel Yagil, Ramat Hasharon (IL); Ofir Shalvi, Herzlia (IL)

Correspondence Address: TEXAS INSTRUMENTS INCORPORATED, P O BOX 655474, M/S 3999, DALLAS, TX, 75265

(21) Appl. No.: 09/902,447

(22) Filed: Jul. 10, 2001

Related U.S. Application Data
(60) Provisional application No. 60/216,997, filed on Jul. 10, 2000.

(51) Int. Cl. H04N 7/173

(52) U.S. Cl. 725/111; 725/125

(57) ABSTRACT

A method, device and system are provided for a physical layer for a CATV upstream channel. A group of features is provided to address increased capacity and robustness to noise, while at the same time keeping cost and complexity to a minimum. Other methods and systems are also provided.

### 1. INTRODUCTION

{Explain the targets of the HiPHYL ite, which are enhancing DOCSIS 1.1. Explain that this spec achieves all the main advantages of the much more complicated HI PHY spec, in terms of throughput and robustness, with very minor cost addition}

### 2. PROPOSED UPSTREAM HI-PHY LITE SYSTEM

We propose the following modifications to the DOCSIS 1.0 spec:

64-QAM constellation

This feature allows 50% increase of channel throughput (up to 6 bits per symbol) in high quality upstream plants.

5.12 Mbaud symbol rate

This feature allows better channel utilization by the MAC layer. It allows reducing the number of receivers in the CMTS, thus reducing its size and cost. Higher symbol rate also allows for lower power consumption (since the CM needs to transmit a smaller portion of the time), and can allow for better robustness to narrowband ingress noise and to short noise impulses.

1 Kbyte Byte interleaver

This feature allows better robustness to burst and impulse noise.

Linear pre-equalizer

This feature, which is already included in the DOCSIS spec, and implemented in most DOCSIS 1.0 systems, allows improving system's robustness to linear distortions.

These features are rather simple and low cost in terms of implementation and testing, but they achieve most of the improvements that are achievable with the much more complicated IEEE802.14a scheme.

### 3. PERFORMANCE

3.1. White Noise

A. Throughput Versus SNR

Table 1 shows the white noise performance that can be achieved by a HiPHY Lite system using the DOCSIS error correction code (Reed-Solomon T=0 . . . 10, k=16 . . . 255):

TABLE 1
HiPHY Lite Throughput

| | Throughput | SNR (Es/N0) required for |
|---|---|---|
| Constellation | [bits/symbol] | post FEC BER = 10⁻⁸ |
| QPSK | 1.82 | 9.9 dB |
| 16QAM | 3.64 | 16.7 dB |
| 64QAM | 5.45 | 22.7 dB |

As one can see, 64 QAM modulation is easily at SNR of above 23-25 dB which is believed to represent the SNR levels in “clean” CATV plants. Note that DOCSIS 1.0 system achieve the same performance in the case of QPSK and 16 QAM modulations.

Table 2 compares the SNR required for achieving BER=10⁻⁸ by the HI-PHY Lite (with DOCSIS 1.0 Reed-Solomon error correction code), and the IEEE802.14a draft spec (using either Trellis Coded Modulation or Bit Interleaved Coded Modulation concatenated with Reed-Solomon error correction code).

TABLE 2
HiPHY Lite versus IEEE802.14a

| | Throughput | DOCSIS 1.0 | IEEE802 | IEEE802 |
|---|---|---|---|---|
| Constellation | [bits/symbol] | FEC | TCM | BICM |
| QPSK | 1.82 | 9.9 dB | 8.1 dB | 7.9 dB |
| 16QAM | 3.64 | 16.7 dB | 15.1 dB | 15.3 dB |
| 64QAM | 5.45 | 22.7 dB | 21.2 dB | 21.7 dB |

The table refers to the case of 1000 bytes packets in the TDMA mode¹ of the IEEE spec. As one can see, the difference in performance is 1-2 dB. We believe that this small improvement in performance does not justify the added complexity due to the TCM and the BICM codes (which further require inner interleaving and non-linear precoding), and thus we excluded these codes from the HiPHY Lite proposal. We note that in the case of smaller packets, the benefits of the TCM and BICM codes become even smaller, and the performance of the complex IEEE802.14a modulation converges to that of the HiPHYLite. ¹ The SNR required by the IEEE802.14a in the case of S-CDMA modulation is higher by a fraction of a dB than the SNR required in the case of TDMA shown in table 2.

B. Fine Granularity

In many channels the SNR will be higher than required for one constellation (e.g. 16 QAM), but not high enough for a higher order constellation (e.g. 64 QAM). In such channels it is desirable to transmit a continuous number of bits per symbol which is a compromise between the two constellations.

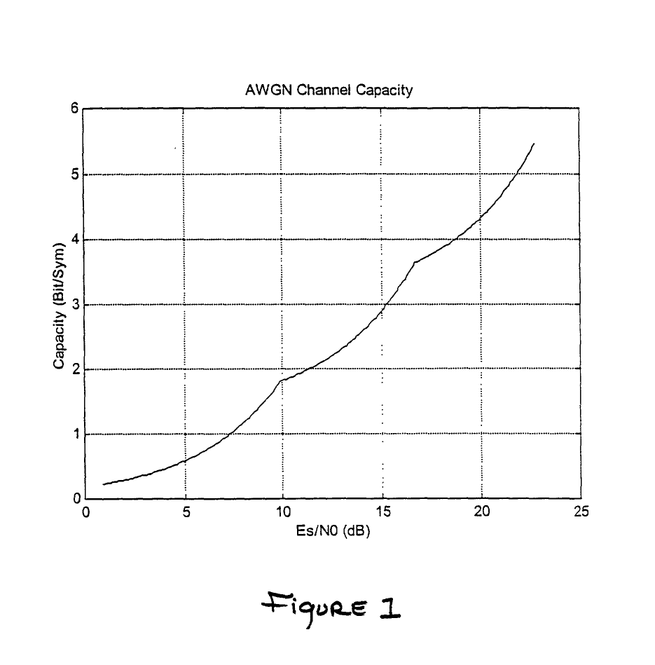

The HiPHY Lite (as well as the DOCSIS 1.0) system allows fine granularity for matching the overall throughput of the system to the channel SNR. FIG. 1 shows the SNR levels required for achieving any throughput in the range of 0.225 to 6 bits per symbol. The fine granularity is achieved by using one constellation in one part of the upstream band and a higher constellation in the other part. This assumes two or more upstream signals. Thus the HiPHY Lite (or DOCSIS) scheme is equivalent to S-CDMA scheme in the sense of achieving fine granularity (wherein in the S-CDMA scheme, fine granularity is achieved by using different constellations in different codes).

C. Operation in Very Low SNR

The HiPHY Lite (as well as DOCSIS 1.0) allows operation at very low SNR levels. This is achieved by reducing the system throughput. As shown in FIG. 1 the DOCSIS/HI-PHY Lite system can reduce its effective data rate to as low as 0.11 bits per symbol and operate at SNR levels that can be as low as −2 dB (that is the noise is stronger by 2 dB than the signal). In order to operate at the low SNR range, the CM transmits at the lower baud rates of DOCSIS (e.g. 160 Kbaud), at a boosted power level. This is feasible since the analog front end of the CM is designed to support a high baud rate signal (e.g. a 2.56 Mbaud signal) whose power level is higher by a factor of 16 (12 dB). This is similar to the capability of an S-CDMA system to operate at low SNR levels by reducing the number of codes.

3.2. Ingress Noise Performance

HiPHY Lite and DOCSIS 1.0 systems can operate in the presence of heavy narrowband ingress using well known techniques such as Decision Feedback Equalization (DFE) at the headend. The DFE has two key advantages:

Mitigation of narrowband ingress and colored noise

The SNR that can be achieved by a DFE is given by:

$$SNR = exp \{ - \frac{T}{2 π} \int ln [ 1 + SNR ( w ) ] ⅆ w \} \qquad ( 1 )$$

Where SNR(w) is the ratio between the signal and the noise spectral densities at frequency w.

Example: consider the case of a 1.28M symbols per second channel suffering from a single narrowband ingress source that is centered near the center of the channel, has a 3 dB bandwidth of 12.8 kHz, a spectral rolloff of 20 dB per decade, and an SNR level is 6 dB². A DFE will be capable of achieving in this case an SNR level of 23.7 dB which is an improvement of 17.7 dB compared to the non equalized case³. Using a DFE enables 64 QAM modulation. We are not aware of any practical method that will yield such a large equalization gain with S-CDMA modulation. ² The noise spectrum is given by Sₙ(w)=min{1,⅛(B/(w−w₀))²}, where B is the bandwidth of the ingress signal (12800 Hz)w₀ is its center frequency. ³ Note that an optimal linear equalizer achieves in this case SNR of 11.3 dB, which only allows for QPSK modulation.

Fast Tracking of dynamic ingress characteristics

The DFE is capable of tracking rapid changes in the levels, center frequencies and spectral shapes of the ingress sources within few hundreds of microseconds.

The IEEE802.14a includes a Tomlinson-Harashima (TH) non-linear precoder at the CM, which allows combating narrowband ingress with TDMA signals. TH precoding is better than DFE in terms of preventing error propagation in the receiver. However, DFE is clearly preferable to TH preceding, since it allows somewhat lower transmission power, it allows less complicated and lower cost client units, and most importantly, it allows fast adaptation to dynamic noise. TH preceding requires a non-practical ranging and messaging process in order to combat rapid noise variations.

3.3. Burst Noise Performance

The DOCSIS 1.0 scheme combats burst noise by using Reed-Solomon error correction codes. These codes can correct up to T byte errors, where T=0 . . . 10. The maximal burst length that can be corrected by a DOCSIS 1.0 system is

T_{BURST}=T/R_{byte}

Where T is the correction factor of the code, and R_{byte} is the byte rate of the channel.

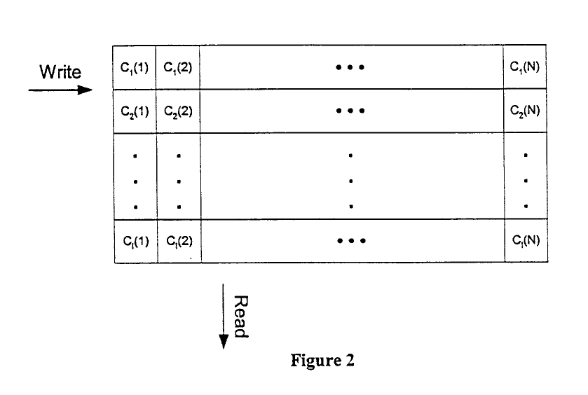

The HiPHY Lite scheme employs a block byte interleaver that allows significantly improving burst correction capability. The byte interleaver is shown in FIG. 2. It is a two-dimensional memory structure with N columns and I rows, where N is the Reed-Solomon code-word length. The interleaver performs permutations on a block of N×I data bytes in the following way: The bytes are written into the interleaver row by row, and read from the interleaver column by column (see FIG. 2).

When a byte interleaver is used, the maximum burst length that can be corrected by a HiPHY Lite system is multiplied by the interleaver depth (I), that is:

T_{BURST}=I×T/R_{byte}.

When the SNR in the channel is high, 64-QAM modulation can be used in conjunction with low code-rate Reed-Solomon code and byte interleaving to further increase burst noise robustness.

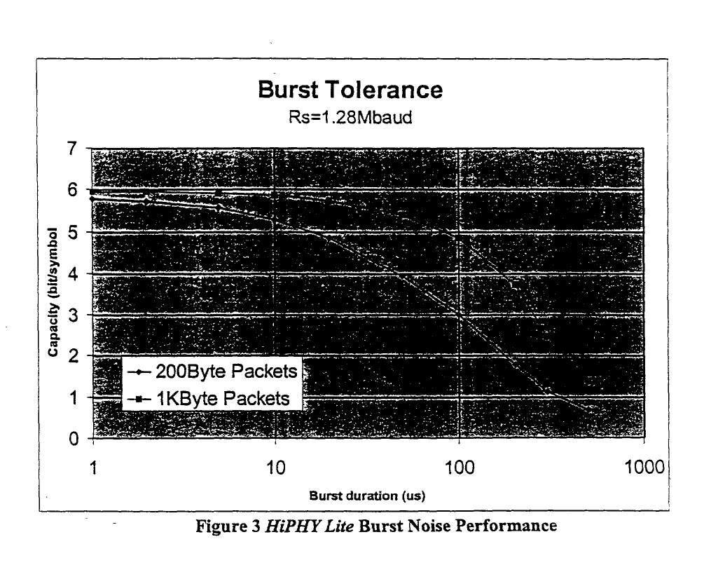

FIG. 3 shows the attainable throughput of a HiPHY Lite system as a function of the burst length that the system can tolerate. Performance is analyzed for moderate size packets (200 bytes) and long packets (1 Kbyte).

For 200 byte packets, interleaving is limited, thus burst tolerance performance is degraded. For comparison, DOCSIS 1.1 frames can tolerate bursts that are shorter than 7 us for 64-QAM, 13 us for 16-QAM and 30 us for QPSK. In IEEE802.14a spec, burst tolerance is double tolerance of Hi-PHY Lite tolerance (for long packets), due to a byte interleaver with memory of 2048 bytes. We believe that 1028 byte interleaver is a better trade-off choice between cost and performance.

Note that when extremely large noise bursts are present, they can be tolerated by reducing the baud rate (burst tolerance is increased by the factor of baud rate decrease).

We observe that the HiPHY Lite system can easily tolerate bursts of up to 10 microseconds, which covers the vast majority of the noise bursts in the system. By gradually trading throughput for burst noise robustness, the system can tolerate bursts of up to 500 microseconds, which are considered to be rare.

It is important to note that the burst robustness is proportional to the symbol rate, and it can be further improved by up to a factor of 8 by using the lower symbol rates of DOCSIS. This increases the number of upstream channels and may sacrifice MAC layer efficiency, but it provides a pragmatic solution for the very rare cases of frequent occurrence of very long noise bursts (more than 100 microseconds).

We conclude that by using HiPHY Lite, the cable operator can achieve extremely high robustness to long noise bursts by using low symbol rates and/or slightly lower throughput.

3.4 Inter-Symbol-Interference

The HiPHY Lite scheme includes an 8 taps linear pre-equalizer at the CM. Such an equalizer is already supported by the DOCSIS 1.0 scheme (although not mandatory) and included in most DOCSIS 1.0 CM's.

The inter-symbol-interference (ISI) in the upstream channel is mainly a result of reflections and of linear distortions of the diplexers in the plant. The ISI is typically mild and can be compensated in a nearly optimal manner by means of linear equalization. Thus the HiPHY Lite scheme is effectively equivalent in its ISI cancellation performance to the much more complicated equalization scheme of the IEEE802.14a (non-linear precoder with 24 taps).

3.5 Impulse Noise Performance

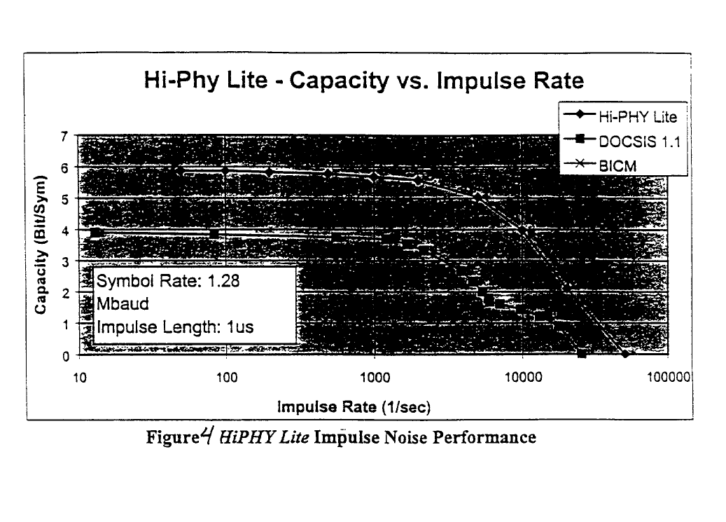

FIG. 4 shows the attainable throughput of the DOCSIS 1.0, HiPHY Lite and IEEE 802.14a TDMA schemes. We have simulated a 1.28M symbols per second channel with 1000 bytes data packets. The noise impulses are 1 microsecond each, and the SNR is −5 dB within the impulses and 25 dB otherwise. The impulses appear randomly in time (Poisson distribution) and the horizontal axis of the figure is the average number of impulses per second.

We observe that the HiPHY Lite scheme can easily tolerate 1000 impulses per second and by trading data rate it can tolerate up to 25000 impulses per second. The DOCSIS 1.0 scheme is inferior to the HiPHY Lite mainly due to lacking 64QAM modulation. However, both the HiPHY Lite and the DOCSIS 1.0 schemes are capable of operating in scenarios of 1000-10000 impulses per second which are believed to represent the toughest upstream channels. The IEEE802.14a scheme can tolerate higher impulse noise rates due to using Bit Interleaved Coded Modulation, which is very robust to impulse noise.

What is claimed is:

1. The method and apparatus substantially as shown and described.
